(19) United States
(12) Patent Application Publication
(10) Pub. No.: US 2012/0233086 A1
(43) Pub. Date: Sep. 13, 2012

(54) APPARATUS AND METHOD FOR ESTIMATING WORKLOAD

(75) Inventor: Sang Hoon SHIN, Gyeongnam (KR)

(73) Assignee: Electronics and Telecommunications Research Institute, Daejeon (KR)

(21) Appl. No.: 13/353,493

(22) Filed: Jan. 19, 2012

(30) Foreign Application Priority Data
Mar. 11, 2011 (KR) 10-2011-0021835

(51) Int. Cl. G06Q 50/28

(52) U.S. Cl. 705/338

(57) ABSTRACT

The apparatus includes a route manager configured to generate comparison result information by comparing an actual travel route of a mail carrier with an optimum service route on the basis of obtained global positioning system (GPS) information and then provide the generated comparison result information, a delivery point determiner configured to determine a delivery point on the basis of the obtained GPS information and provide information about the determined delivery point, a GPS information statistics unit configured to provide statistical information obtained by interpreting the obtained GPS information, and an information output unit configured to convert information obtained from one of the route manager, the delivery point determiner, and the GPS information statistics unit to be output as a document, or process the information to be checked by the mail carrier through a user interface (UI). Accordingly, efficiency of a collection and delivery service can be improved.

### CLAIM FOR PRIORITY

This application claims priority to Korean Patent Application No. 10-2011-0021835 filed on Mar. 11, 2011 in the Korean Intellectual Property Office (KIPO), the entire contents of which are hereby incorporated by reference.

### BACKGROUND

1. Technical Field

Example embodiments of the present invention relate in general to estimation of a workload, and more particularly, to an apparatus and method for estimating a workload using global positioning system (GPS) information.

2. Related Art

Recently, a great number of GPS-based navigation systems have come into use, and position determination technology using a GPS satellite is being employed in various fields such as precise timing synchronization, geodetic surveying, navigation of ships, and navigation devices of conveyances including cars, airplanes, etc. A GPS satellite continuously transmits visual information, its own orbital information, brief orbital information about all satellites, reliability of each piece of information, and information about error correction factors required for navigation.

Meanwhile, to deliver a postal matter to a customer or collect delivery items from customers, a post office mail carrier should perform a delivery or collection while moving along a delivery route in a delivery zone, which is referred to as a collection and delivery service. Postal matters include recorded postal matters whose route and information are managed, and unrecorded postal matters whose route and information are not managed. Both recorded postal matters and unrecorded postal matters are handled by the collection and delivery service.

Thus far, mail carriers have performed the collection and delivery service with reference to maps according to their experience after delivery quantities and locations are determined. Also, during the collection and delivery service of a mail carrier, information about collection and delivery service routes and collection and delivery service time periods for unrecorded postal matters, and the quantity of the postal matters have been subjectively recorded according to the mail carrier's experience. Consequently, a workload of a mail carrier cannot be objectively determined, and efficiency of the collection and delivery service deteriorates.

### SUMMARY

Accordingly, example embodiments of the present invention are provided to substantially obviate one or more problems due to limitations and disadvantages of the related art.

Example embodiments of the present invention provide a global positioning system (GPS) information-based workload estimation apparatus for objectively finding a workload of a collection and delivery service using GPS information and increasing efficiency of the collection and delivery service.

Example embodiments of the present invention also provide a GPS information-based workload estimation method for increasing efficiency of a collection and delivery service and objectively finding a workload of the collection and delivery service using GPS information.

In some example embodiments, an apparatus for estimating a workload includes: a route manager configured to generate comparison result information by comparing an actual travel route of a mail carrier with an optimum service route on the basis of obtained GPS information, and then provide the generated comparison result information; a delivery point determiner configured to determine a delivery point on the basis of the obtained GPS information and provide information about the determined delivery point; a GPS information statistics unit configured to provide statistical information obtained by interpreting the obtained GPS information; and an information output unit configured to convert information obtained from one of the route manager, the delivery point determiner, and the GPS information statistics unit to be output as a document, or process the information to be checked by the mail carrier through a user interface (UI). The obtained GPS information may include at least one of the mail carrier's travel distance information, travel time information, travel speed information, stop location information, optimum service route information, actual travel route information, and information about a time for which the mail carrier has stayed at a predetermined place. When a condition that the mail carrier stay within a predetermined range of a predetermined place for a predetermined time or more is satisfied while the mail carrier performs a collection and delivery service on the basis of the obtained GPS information, the delivery point determiner may determine the predetermined place satisfying the condition as a delivery point. The statistical information may include at least one of information about the number of cases in which the optimum service route provided by a GPS-mounting device differs from the actual travel route, information about a difference in time to perform a collection and delivery service when the optimum service route provided by the GPS-mounting device differs from the actual travel route, information about an average travel speed of the mail carrier for the collection and delivery service, information about the daily average number of delivery points, and information about whether the mail carrier travels by foot or a means of transportation.

In other example embodiments, a method of estimating a workload includes: generating at least one of comparison result information obtained by comparing an actual travel route of a mail carrier with an optimum service route on the basis of obtained GPS information, delivery point information obtained by determining a delivery point on the basis of the obtained GPS information, and statistical information obtained by interpreting the obtained GPS information; and converting at least one of the comparison result information, the delivery point information, and the statistical information to be output as a document, or processing the information to be checked by the mail carrier through a UI. The obtained GPS information may include at least one of the mail carrier's travel distance information, travel time information, travel speed information, stop location information, optimum service route information, actual travel route information, and information about a time for which the mail carrier has stayed for his/her work at one place. Generating at least one of the comparison result information, the delivery point information, and the statistical information may include, when a condition that the mail carrier stay within a predetermined range of a predetermined place for a predetermined time or more is satisfied while the mail carrier performs a collection and delivery service on the basis of the obtained GPS information, determining the predetermined place satisfying the condition as a delivery point. The statistical information may include at least one of information about the number of cases in which the optimum service route provided by a GPS-mounting device differs from the actual travel route, information about a difference in time to perform a collection and delivery service when the optimum service route provided by the GPS-mounting device differs from the actual travel route, information about an average travel speed of the mail carrier for the collection and delivery service, information about the daily average number of delivery points, and information about whether the mail carrier travels by foot or a means of transportation.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing a constitution of a system for estimating a workload using global positioning system (GPS) information according to an example embodiment of the present invention;

FIG. 2 is a block diagram of an apparatus for estimating a workload using GPS information according to an example embodiment of the present invention; and

FIG. 3 is a flowchart illustrating a method of estimating a workload using GPS information according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the accompanying drawings. Like numbers refer to like elements throughout the description of the drawings, and description of the same element will not be reiterated.

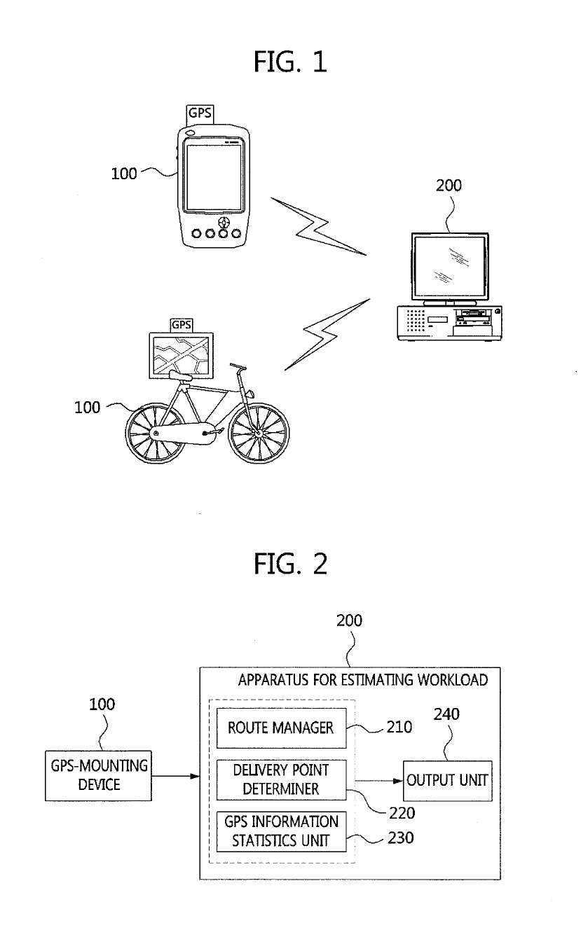

FIG. 1 is a conceptual diagram showing a constitution of a system for estimating a workload using global positioning system (GPS) information according to an example embodiment of the present invention.

Referring to FIG. 1, a system for estimating a workload using GPS information according to an example embodiment of the present invention includes a GPS-mounting device 100 and a workload estimation apparatus 200.

The GPS-mounting device 100 has a keypad or voice input unit. Thus, when address information is input by a mail carrier's keypad manipulation or voice, the GPS-mounting device 100 obtains the input address information. Here, the GPS-mounting device 100 may be any device having a GPS function, for example, a GPS receiver or a portable terminal having a built-in GPS chip.

Subsequently, the GPS-mounting device 100 computes a delivery route for the obtained address information and location data of the mail carrier received through a GPS service using a geographic information system (GIS), generates the optimum delivery route (or shortest delivery route), and provides the generated optimum delivery route (or shortest delivery route).

When the UPS-mounting device 100 provides the generated optimum delivery route (or shortest delivery route), the optimum delivery route (or shortest delivery route) may be converted into image map information and/or voice information. In other words, the converted image map information may be displayed, and the converted voice information may be provided so that the mail carrier can check or recognize the voice information.

Thus, the mail carrier does not need to input a next delivery destination every time he/she arrives at a delivery place, and only needs to move along a route provided by the GPS-mounting device 100, thus efficiently performing his/her work.

When it is determined that the mail carrier has strayed from a route provided by the GPS-mounting device 100 during a delivery service, the GPS-mounting device 100 searches for a new route and provides the searched new route.

Also, the GPS-mounting device 100 stores GPS information, for example, total travel distance information, total travel time information, overall average travel speed information, inter-delivery-point travel distance information, inter-delivery-point travel time information, and average inter-delivery-point travel speed information, received through the GPS service for the mail carrier, and stores stop time information, location information (e.g., latitude and longitude), etc. in time sequence.

The GPS-mounting device 100 can be connected with an external device through an external device connection interface (not shown), for example, a universal serial bus (USB), Bluetooth, or wireless fidelity (WiFi), and may provide the stored GPS information to the workload estimation apparatus 200.

The workload estimation apparatus 200 obtains the GPS information provided by the GPS-mounting device 100 and may compare information about an actual travel route for a collection and delivery service of the mail carrier with optimum route information provided by the GPS-mounting device 100 on the basis of the obtained GPS information. Also, the workload estimation apparatus 200 may determine a delivery point on the basis of the obtained GPS information, and generate statistical information by interpreting the mail carrier's travel distance and travel time, a time for which the mail carrier has stayed at one place, etc. on the basis of the obtained GPS information.

The workload estimation apparatus 200 obtains comparison information obtained by comparing the mail carrier's actual travel route information with the optimum route information, the delivery point information, and the statistical information, converts the obtained information into a format such as a text document, an Excel sheet, or a statistical graph, and provides the converted information, so that an administrator can check the information using various software programs. Also, the workload estimation apparatus 200 may process the obtained information so that the mail carrier can check the information through a user interface (UI).

FIG. 2 is a block diagram of an apparatus 200 for estimating a workload using GPS information according to an example embodiment of the present invention.

Referring to FIG. 2, the apparatus 200 for estimating a workload may include a route manager 210, a delivery point determiner 220, a GPS information statistics unit 230, and an output unit 240.

First, the route manager 210 obtains GPS information from a GPS-mounting device 100 when a mail carrier finishes the collection and delivery service and returns to a collection and delivery station or post office to connect an external device connection interface of the apparatus 200 for estimating a workload with the GPS-mounting device 100. Here, the GPS information may be, for example, the mail carrier's travel distance information, travel time information, travel speed information, stop location information, optimum service route information, actual travel route information, and information about a time for which the mail carrier has stayed for the service at one place.

The route manager 210 reads out information about an actual travel route for the mail carrier to perform the collection and delivery service and optimum service route information provided by the GPS-mounting device 100 from the obtained GPS information, and then generates comparison result information by comparing the read actual travel route with the read optimum service route. The route manager 210 provides the generated comparison result information to the output unit 240.

The delivery point determiner 220 obtains GPS information from the GPS-mounting device 100 when the mail carrier finishes the collection and delivery service and returns to a collection and delivery station or post office to connect the external device connection interface of the apparatus 200 for estimating a workload with the GPS-mounting device 100. Here, the GPS information may be, for example, the mail carrier's travel distance information, travel time information, travel speed information, stop location information, optimum service route information, actual travel route information, and information about a time for which the mail carrier has stayed at a predetermined place.

The delivery point determiner 220 reads out information about a time for which the mail carrier has stayed at a predetermined place and stop location information from the obtained GPS information, and determines a delivery destination (referred to as a “delivery point” below) on the basis of the read information. Specifically, when the mail carrier stays within a predetermined range of a spot for a predetermined time during the collection and delivery service, a condition previously set in the apparatus 200 for estimating a workload (e.g., the mail carrier stays within three meters of a predetermined place for five seconds or more) may be satisfied. In this case, the delivery point determiner 220 determines the spot satisfying the condition as a delivery point. A result of an experiment for determining delivery points on the basis of a case in which one mail carrier in a predetermined region stays within three meters of a predetermined place for more than three seconds during the collection and delivery service is similar to the number of actual delivery points.

Also, the delivery point determiner 220 provides information about the determined delivery points to the output unit 240.

The GPS information statistics unit 230 obtains the GPS information from the UPS-mounting device 100 when the mail carrier finishes the collection and delivery service and returns to a collection and delivery station or post office to connect the external device connection interface of the apparatus 200 for estimating a workload with the GPS-mounting device 100.

Here, the obtained GPS information may be, for example, the mail carrier's travel distance information, travel time information, travel speed information, stop location information, optimum service route information, actual travel route information, and information about a time for which the mail carrier has stayed at a predetermined place.

Also, the GPS information statistics unit 230 provides statistical information (e.g., information about the number of cases in which the optimum service route provided by the GPS-mounting device 100 differs from the actual travel route, information about a difference in time to perform the collection and delivery service when the optimum service route provided by the GPS-mounting device 100 differs from the actual travel route, information about an average travel speed of the mail carrier for the collection and delivery service, information about the daily average number of delivery points, and information about whether the mail carrier travels by foot or a means of transportation) obtained by interpreting the obtained GPS information to the output unit 240.

The output unit 240 converts the information obtained from the route manager 210, the delivery point determiner 220, and/or the GPS information statistics unit 230 into a format such as a text document, an Excel sheet, or a statistical graph, and provides the converted information, so that an administrator can check the obtained information using various software programs. Also, the output unit 240 may perform a graphic process to enable the mail carrier to visually check the obtained information through a UI, and may display the route information interpreted by the route manager 210, the information about the delivery points determined by the delivery point determiner 220, and/or the statistical information provided by the GPS information statistics unit 230 on the UI.

Here, information displayed by the output unit 240 is, for example, the mail carrier's travel distance information, travel time information, travel speed information, stop location information, optimum service route information, actual travel route information, information about a time for which the mail carrier has stayed at a predetermined place, information about the number of cases in which the optimum service route provided by the GPS-mounting device 100 differs from the actual travel route, information about a difference in time to perform the collection and delivery service when the optimum service route provided by the GPS-mounting device 100 differs from the actual travel route, information about an average travel speed of the mail carrier for the collection and delivery service, overall average travel speed information, inter-delivery-point travel distance information, inter-delivery-point travel time information, average inter-delivery-point travel speed information, and information about the daily average number of delivery points.

Information displayed by the output unit 240 is based on GPS information, and thus is objective information that is not obtained from the viewpoint of the mail carrier. On the basis of such objective information, it is possible to check workloads of respective mail carriers and determine whether the respective mail carriers efficiently perform the collection and delivery service.

In other words, when one mail carrier has a heavy workload, the quantity of delivery items may be properly distributed so that the collection and delivery service can be efficiently performed. Also, a supervisor may be able to determine whether a mail carrier faithfully performs the collection and delivery service on the basis of travel time between delivery points, a time for which the mail carrier stays at one place, and so on.

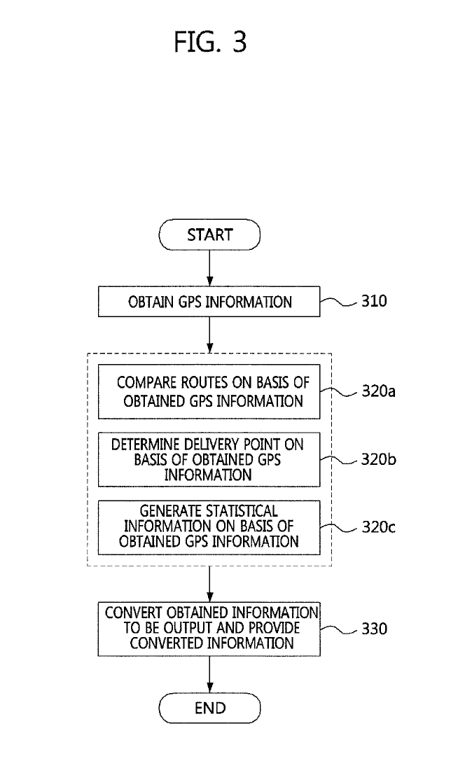

FIG. 3 is a flowchart illustrating a method of estimating a workload using GPS information according to an example embodiment of the present invention.

Referring to FIG. 3, a workload estimation apparatus according to an example embodiment of the present invention obtains GPS information from a GPS-mounting device (step 310). Specifically, when a mail carrier finishes his/her work and returns to a collection and delivery station or post office to connect an external device connection interface of the workload estimation apparatus with the GPS-mounting device, GPS information may be obtained from the GPS-mounting device.

Here, the obtained GPS information may be, for example, the mail carrier's travel distance information, travel time information, travel speed information, stop location information, optimum service route information, actual travel route information, and information about a time for which the mail carrier has stayed at a predetermined place.

The workload estimation apparatus reads out information about an actual travel route for the mail carrier to perform the collection and delivery service and optimum service route information provided by the GPS-mounting device from the obtained GPS information, generates comparison result information by comparing the read actual travel route with the read optimum service route, and then provides the generated comparison result information (step 320a).

Also, the workload estimation apparatus reads out information about a time for which the mail carrier has stayed at a predetermined place and stop location information from the obtained GPS information, determines a delivery destination (referred to as a “delivery point” below) on the basis of the read information, and provides the information about the determined delivery point and the obtained GPS information (step 320b).

Specifically, when the mail carrier stays within a predetermined range of a spot for a predetermined time during the collection and delivery service, a condition previously set in the workload estimation apparatus (e.g., the mail carrier stays within three meters of a predetermined place for five seconds or more) may be satisfied. In this case, the workload estimation apparatus determines the spot satisfying the condition as a delivery point. A result of an experiment for determining delivery points on the basis of a case in which one mail carrier in a predetermined region stays within three meters of a predetermined place for more than three seconds during the collection and delivery service is similar to the number of actual delivery points.

Also, the workload estimation apparatus generates statistical information (e.g., information about the number of cases in which the optimum service route provided by the GPS-mounting device differs from the actual travel route, information about a difference in time to perform the collection and delivery service when the optimum service route provided by the GPS-mounting device differs from the actual travel route, information about an average travel speed of the mail carrier for the collection and delivery service, information about the daily average number of delivery points, and information about whether the mail carrier travels by foot or a means of transportation) by interpreting the obtained GPS information to find a collection and delivery service workload of the mail carrier, and provides the generated statistical information (step 320c).

The workload estimation apparatus obtains information through step 320a, step 320b, and/or step 320c, converts the obtained information into a format such as a text document, an Excel sheet, or a statistical graph, and provides the converted information, so that an administrator can check the obtained information using various software programs. Also, the workload estimation apparatus may perform a graphic process to enable the mail carrier to visually check the obtained information through a UI, and may display the route information interpreted in step 320a, the information about the delivery points determined in step 320b, and/or the statistical information provided in step 320c on the UI (step 330).

Here, information displayed through an output unit is, for example, the mail carrier's travel distance information, travel time information, travel speed information, stop location information, optimum service route information, actual travel route information, information about a time for which the mail carrier has stayed at a predetermined place, information about the number of cases in which the optimum service route provided by the GPS-mounting device differs from the actual travel route, information about a difference in time to perform the collection and delivery service when the optimum service route provided by the GPS-mounting device differs from the actual travel route, overall average travel speed information, inter-delivery-point travel distance information, inter-delivery-point travel time information, average inter-delivery-point travel speed information, and information about the daily average number of delivery points.

Information displayed by the workload estimation apparatus is based on GPS information, and thus is objective information that is not obtained from the viewpoint of a mail carrier. On the basis of such objective information, it is possible to check workloads of respective mail carriers and determine whether the respective mail carriers efficiently perform the collection and delivery service.

In other words, when one mail carrier has a heavy workload, the quantity of delivery items may be properly distributed so that the collection and delivery service can be efficiently performed. Also, a supervisor may be able to determine whether a mail carrier faithfully performs the collection and delivery service on the basis of travel time between delivery points, a time for which the mail carrier stays at one place, and so on.

The above-described apparatus for estimating a workload according to an example embodiment of the present invention includes a route manager configured to generate comparison result information by comparing an actual travel route of a mail carrier with an optimum service route on the basis of obtained GPS information and then provide the generated comparison result information, a delivery point determiner configured to determine a delivery point on the basis of the obtained GPS information and provide information about the determined delivery point, a GPS information statistics unit configured to interpret the obtained GPS information and provide statistical information about the interpreted GPS information, and an information output unit configured to convert information obtained from one of the route manager, the delivery point determiner, and the GPS information statistics unit to be output as a document, or process the information to be checked by the mail carrier through a UI.

Consequently, it is possible to objectively find a workload of a collection and delivery service using GPS information and efficiently perform the collection and delivery service.

While the example embodiments of the present invention and their advantages have been described in detail, it should be understood that various changes, substitutions and alterations may be made herein without departing from the scope of the invention.

What is claimed is:

1. An apparatus for estimating a workload, comprising:
a route manager configured to generate comparison result information by comparing an actual travel route of a mail carrier with an optimum service route on the basis of obtained global positioning system (GPS) information, and then provide the generated comparison result information;
a delivery point determiner configured to determine a delivery point on the basis of the obtained GPS information and provide information about the determined delivery point;
a GPS information statistics unit configured to provide statistical information obtained by interpreting the obtained GPS information; and
an information output unit configured to convert information obtained from one of the route manager, the delivery point determiner, and the GPS information statistics unit to be output as a document, or process the information to be checked by the mail carrier through a user interface (UI).

2. The apparatus of claim 1, wherein the obtained GPS information includes at least one of the mail carrier's travel distance information, travel time information, travel speed information, stop location information, optimum service route information, actual travel route information, and information about a time for which the mail carrier has stayed at a predetermined place.

3. The apparatus of claim 1, wherein, when a condition that the mail carrier stay within a predetermined range of a predetermined place for a predetermined time or more is satisfied while the mail carrier performs a collection and delivery service on the basis of the obtained GPS information, the delivery point determiner determines the predetermined place satisfying the condition as a delivery point.

4. The apparatus of claim 1, wherein the statistical information includes at least one of information about a number of cases in which the optimum service route provided by a GPS-mounting device differs from the actual travel route, information about a difference in time to perform a collection and delivery service when the optimum service route provided by the GPS-mounting device differs from the actual travel route, information about an average travel speed of the mail carrier for the collection and delivery service, information about a daily average number of delivery points, and information about whether the mail carrier travels by foot or a means of transportation.

5. A method of estimating a workload, comprising:
generating at least one of comparison result information obtained by comparing an actual travel route of a mail carrier with an optimum service route on the basis of obtained global positioning system (GPS) information, delivery point information obtained by determining a delivery point on the basis of the obtained GPS information, and statistical information obtained by interpreting the obtained GPS information; and
converting at least one of the comparison result information, the delivery point information, and the statistical information to be output as a document, or processing the information to be checked by the mail carrier through a user interface (UI).

6. The method of claim 5, wherein the obtained GPS information includes at least one of the mail carrier's travel distance information, travel time information, travel speed information, stop location information, optimum service route information, actual travel route information, and information about a time for which the mail carrier has stayed for his/her work at one place.

7. The method of claim 5, wherein generating at least one of the comparison result information, the delivery point information, and the statistical information includes, when a condition that the mail carrier stay within a predetermined range of a predetermined place for a predetermined time or more is satisfied while the mail carrier performs a collection and delivery service on the basis of the obtained GPS information, determining the predetermined place satisfying the condition as a delivery point.

8. The method of claim 5, wherein the statistical information includes at least one of information about a number of cases in which the optimum service route provided by a GPS-mounting device differs from the actual travel route, information about a difference in time to perform a collection and delivery service when the optimum service route provided by the GPS-mounting device differs from the actual travel route, information about an average travel speed of the mail carrier for the collection and delivery service, information about a daily average number of delivery points, and information about whether the mail carrier travels by foot or a means of transportation.
